(19) United States
(12) Patent Application Publication
(10) Pub. No.: US 2026/0044350 A1
(43) Pub. Date: Feb. 12, 2026

(54) NON-PRESCRIPTIVE NATURAL LANGUAGE AS CODE

(71) Applicant: Intel Corporation, Santa Clara, CA (US)

(72) Inventors: Robert Lawson Vaughn, Portland, OR (US); Mateusz Andrzej Socha, Rozyny (PL); Krzysztof Zach, Gdansk (PL)

(73) Assignee: Intel Corporation, Santa Clara, CA (US)

(21) Appl. No.: 19/365,674

(22) Filed: Oct. 22, 2025

(51) Int. Cl. G06F 9/44

(52) U.S. Cl. CPC G06F 9/44

(57) ABSTRACT

A user may express their intent for a program using informal code representations, such as natural language and pseudocode, optionally combined with source code. An artificial intelligence runtime interprets the informal code representation to generate executable code. The user may be prompted by clarifying questions about the program if the artificial intelligence runtime infers that the program is a partial implementation or if ambiguity is present in the program. The informal code representation and the source code may be automatically revised based on the user's responses to the clarifying questions. Once the user has indicated that the program is performing as intended, the executable code associated with the program may be stored as validated executable code without the need to be represented in a higher-level language (e.g., Python, C#). The validated executable code can be used by the artificial intelligence runtime in subsequent executions of the program.

### BACKGROUND

Natural language programming refers to techniques that enable a user to create or modify software by expressing intent in human language rather than through traditional programming syntax. In such systems, a user may describe desired functionality, logic, or behavior using free-form sentences or phrases, which are then interpreted by a natural language processing engine or large language model (LLM) to generate corresponding source code.

### BRIEF DESCRIPTION OF THE DRAWINGS

FIG. 1 illustrates an example interaction between a user and a generative artificial intelligence tool to generate source code from natural language.

FIG. 2 illustrates an example interaction between a user and an integrated development environment to directly generate executable code from informal code representation.

FIG. 3 illustrates an example program comprising source and informal code representation.

FIG. 4 illustrates a sequence diagram for an example interaction between a user and a system to execute a program comprising entirely informal code representation.

FIG. 5 is a block diagram of a first example computing device capable of generating and executing executable code from a program comprising informal code representation.

FIG. 6 is a first example method of generating executable code from a program comprising informal code representation.

FIG. 7 is a second example method of generating executable code from a program comprising informal code representation.

FIG. 8 is a block diagram of a second example computing device capable of generating and executing executable code from a program comprising informal code representation.

FIG. 9 is a block diagram of an example processor unit to execute computer-executable instructions as part of implementing technologies described herein.

### DETAILED DESCRIPTION

In some existing computer program coding approaches, such as co-programming or “vibe programming”, systems have been developed that interpret a programmer's intent expressed in natural language and generate corresponding source code. This can alleviate a user from having to express their intent of what they want a program to accomplish within the confines of programming language syntax and semantics. By being able to express their programmatic intent in natural language, users may be able to create computer code faster and be spared from having to spend the time to learn the syntax, semantics, format, and concepts for a particular programming language.

One example of a co-programming approach is GitHub Copilot, which assists developers by producing code suggestions within an integrated development environment (IDE). For example, when a user enters a comment such as “//Function to remove a specific number from an array,” Copilot automatically generates suitable source code and presents it for user approval. Similar functionality can be achieved using large language models (LLMs) such as ChatGPT, although these typically require the user to specify additional context (e.g., programming language or syntax preferences) and to manually insert source code developed by the LLM into already-existing source code, in the development environment. Such solutions demonstrate the feasibility of natural language-based code generation, but they rely on conventional coding approaches and structured syntax. Emerging approaches, such as vibe programming, allow a user to describe desired functionality in free-form natural language. An LLM trained or tuned for software generation interprets the natural language prompts and produces complete source code implementations.

Described herein are technologies that provide for an artificial intelligence-augmented executable code generation and execution model that allows developers to describe programmatic intent (i.e., what a user wants a computer program to accomplish (e.g., what outputs to generate, what functionality to implement)) in informal code representation or in a mix of informal code representation and source code. Thus, the need for a computer-executable program to be described entirely in source code is eliminated. In some embodiments, programmatic intent is described entirely using informal code representation, and the user expresses programmatic intent in a non-prescriptive manner, and an AI runtime infers what approaches are to be used to achieve the expressed intent.

As used herein, the term “informal code representation” refers to any human-readable expression of computational logic or intent that is not constrained by the syntax or formal grammar of a programming language. Informal code representations include, but are not limited to, pseudocode and natural language. Pseudocode refers to an informal, programming language-agnostic description of program behavior that may incorporate a mixture of plain language, mathematical notation, or limited programming constructs to convey intent without strict adherence to formal syntax. Similarly, natural language refers to intent expressed in natural language form (e.g., “sort the list by date” or “calculate the average temperature”). Both pseudocode and natural language share the property of being informal, in that they express logical or procedural meaning without conforming to a programming language syntax.

By contrast, “source code” is a formally structured set of program instructions written in a defined high-level programming language (e.g., Python, Java, or C++). It expresses computational intent and logic using the language's abstract syntax and semantics intended for human comprehension and modification, and it must conform to that language's syntax and semantic rules so it can be compiled or interpreted into executable form. Unlike informal code representations that describe behavior conceptually, source code represents intent in a syntactically valid, machine-translatable form. Source code is not directly executable by hardware or virtual machines and must first be transformed into executable code through compilation or interpretation.

The term “executable code,” as used herein, encompasses any non-human-readable, machine-interpretable representation of program logic capable of being executed directly or indirectly by a computing system. Executable code, therefore, consists of lower-level instruction formats that can run on hardware or via a runtime, in contrast to source code, which remains a high-level, human-readable form requiring translation before execution.

One example of executable code is bytecode, which is an intermediate, platform-independent representation of program instructions produced from source code by a compiler or interpreter and structured for execution by a software-based virtual machine or runtime environment. Another example of executable code is machine code, which is a hardware-specific, binary-encoded representation of program instructions that is directly executable by a physical processor and that comprises processor-specific instructions.

Instead of requiring manual integration of artificial intelligence-generated source code with already-existing source code, such as in a co-programming context, the technologies disclosed herein directly generate and execute executable code inferred from informal code representation (which can be commingled with source code in a program) and store inferred executable code that has been validated by a user for future runs. These technologies can remove programming language syntax barriers, enabling a higher level of abstraction to be used by users to express intended outcomes. In some embodiments, a runtime can dynamically resolve missing logic to speed up development and ask clarifying questions of a user where user intent may be ambiguous. Thus, the technologies herein can enable consistent and reliable code execution that realizes a user's intent while allowing developers to focus on functionality over computer language formalities.

The technologies described herein eliminate the need for higher-level computer language abstractions, such as Python, by enabling direct understanding, generation, and execution of computational logic from natural language and partial source code program implementations. The disclosed technologies interpret user intent, autonomously detect and correct program failures, and validate execution deterministically before reuse. A memory system stores and retrieves executable code that has been validated by a user, such as bytecode or intermediate code representations, enabling efficient reuse. The disclosed technologies further incorporate self-optimizing execution that balances performance and flexibility, minimizing platform lock-in. Moreover, the disclosed technologies maintain context awareness by recognizing dependencies across functions and modules. Further, the disclosed technologies include security safeguards that prevent artificial intelligence runtimes from executing harmful or unintended operations, and human oversight mechanisms permit developers to audit, verify, and override AI-generated logic. Moreover, the technologies described herein can handle complex programs without performance degradation and can manage programs that comprise multiple program files across multiple systems.

The technologies described herein have at least the following advantages. First, code development can be sped up with the use of artificial intelligence to dynamically resolve missing logic. Second, faster coding is further enabled due to the less effort needed to describe intended behavior and desired outcomes using natural language versus source code, and less training time needed for a user to learn and become adept with a programming language's syntax and programmatic structure. In short, developers do not need to deal with source code. Third, faster code development is additionally enabled by not having to integrate AI-generated source code into existing source code. The informal code representation provided by the user is the “code”. Fourth, the disclosed technologies can manage bytecode generation or abstractions to higher-level languages (source code) without the need for human intervention.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or in any other manner.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

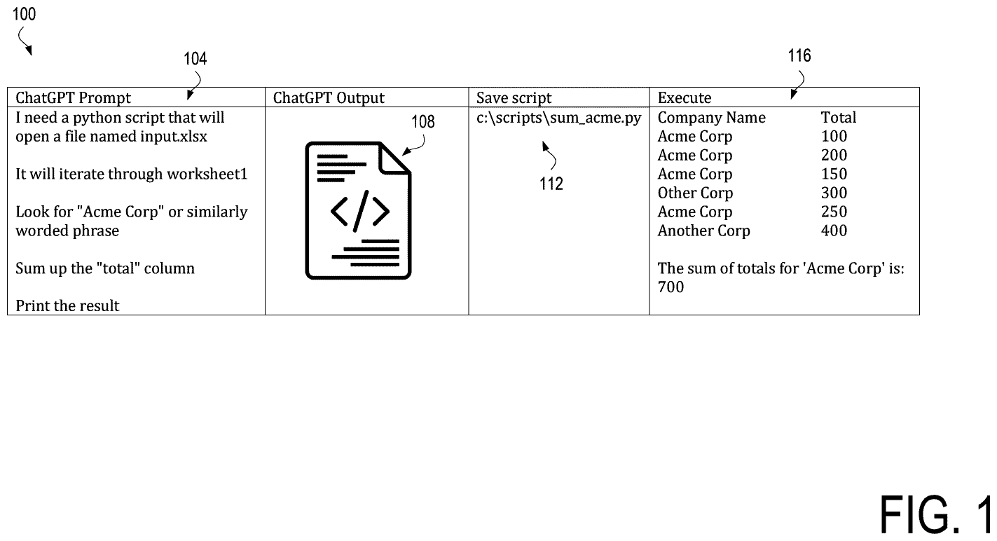

FIG. 1 illustrates an example interaction between a user and a generative artificial intelligence tool to generate source code from natural language. As used herein, the term “generative artificial intelligence tool” (AI tool) refers to software configured to receive a prompt describing programmatic intent in informal code representation form and to generate machine-produced output, including text, software source code, or combinations thereof. The software may be provided as a third-party or proprietary system and may include modules for prompt parsing and model inference, where model inference applies a trained generative model to the prompt to produce output using configured decoding parameters.

The interaction 100 comprises natural language prompts 104 supplied by a user to the AI tool (e.g., ChatGPT) to describe the user's programmatic intent (what the user wants the computer program to do), source code 108 (e.g., a Python script) generated by the AI tool to implement the user's intent (as determined by the AI tool), the name 112 of the source code script to be saved, and output 116 generated upon execution of the generated source code (more specifically, execution of execution code generated from the source code and generated at runtime). As illustrated in FIG. 1, in a co-programming environment, a user can review source code generated by the AI tool and/or output generated by the source code and provide additional prompts to further clarify or modify user intent. These steps can be performed iteratively until the desired output is achieved and final source code is obtained. This final source code can be integrated into an existing software application expressed in source code.

FIG. 1 illustrates an example co-programming context that involves human-AI collaboration. In FIG. 1, a user describes their intent of what they want a program to do in natural language, an AI tool interprets the user's expressed intent to generate source code, and the user subsequently approves, modifies, or integrates the generated source code into existing code. From an optimization perspective, if a user can specify programmatic intent in natural language and the artificial intelligence tool can infer the corresponding logic, then separate steps of generating source from the natural language and manually integrating the generated source code into existing source code may be unnecessary. The technologies described herein enable the capturing of user intent at a higher level of abstraction than source code (via informal code representation) and eliminate the need for a user's intent to be expressed in source code (as either manually written by a user or automatically generated by an AI tool).

One technical challenge addressed by the technologies disclosed herein is that a user may wish to express programmatic intent that adds to or alters the functionality of legacy source code. The technologies described herein allow a user to express programmatic intent not just via informal code representation alone, but also via informal code representation interspersed among source code.

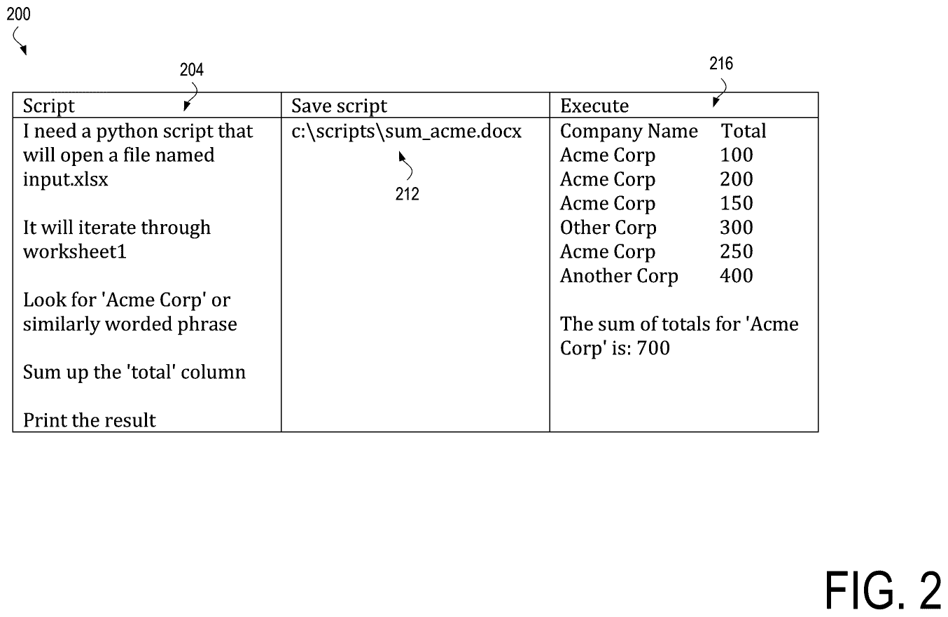

FIG. 2 illustrates an example interaction between a user and an integrated development environment to directly generate executable code from informal code representation. The interaction 200 comprises a user interacting with an integrated development environment (IDE) having generative artificial intelligence capabilities due to having, for example, a large language model (LLM) integrated into the IDE or the IDE having access to an LLM. Such IDEs can be considered to be “LLM-aware”. In some embodiments, as will be discussed, an IDE can have access to an LLM via an LLM execution bridge, which acts as an interface between an IDE and an LLM.

As used herein, the term “integrated development environment” or “IDE” refers to software that provides tools for authoring, editing, navigating, testing, and debugging program source code. An IDE may include a code or text editor, a test runner, and version control integration, and may orchestrate external tools during development. As used herein, the term “runtime” refers to software that generates and executes executable code on one or more processors and manages resources during execution, including memory allocation, scheduling of threads or tasks, input and output operations, and interaction with operating system services. Any of the runtimes described herein can be LLM-aware runtimes that use the LLM to generate executable code from source code and/or informal code representation. As such, an LLM-aware runtime can be referred to herein as an “AI runtime”. In some embodiments, an IDE can comprise a generative AI tool or a generative AI tool platform.

An IDE and runtime can be distinct components. An IDE assists human developers in producing and analyzing code, while the runtime executes compiled or interpreted code. In some embodiments, an IDE may launch or attach to a runtime to run or debug a program, but the IDE remains a development tool and the runtime remains the execution environment.

The interaction 200 comprises a script 204 comprising informal code representation received by the IDE, the name 212 of the script (or program, program file) to be saved, and output 216 generated upon execution of executable code (e.g., bytecode or machine code) generated directly from the script 204. The script 204 can be displayed in a text (or code) editor of an IDE. Notably absent from the interaction 200 is source code generated by the IDE implementing the programmatic intent expressed in the script 204. The executable code used to generate the output 216 is generated directly from the script 204. That is, no source code is generated as an intermediate step as part of generating executable code from the script 204. Reference to executable code generated directly from a script, program, program file, or other source comprising informal code representation (which may be interspersed with existing source code) refers to executable code generated from the script, program, program file, or other source without source code being generated as an intermediate step.

As discussed above, a benefit of the technologies disclosed herein is that developers do not need to deal with source code. The informal code representation expressing programmatic intent (i.e., the script 204) is the “code”. Source code is neither generated by an AI runtime nor saved by an IDE. The script 204, comprising informal code representation, is saved as the “program,” and to run the program expressed by the script 204 at a later time, a user loads the saved script (comprising solely informal code representation), and the IDE “runs” the script.

Although the script 204 is comprised entirely of informal code representation, the technologies herein allow for execution of a program described with a combination of source code and informal code representation. Reference to a “program” herein can refer to a file, program, or script, or prompts supplied to an IDE that expresses programmatic intent in source code, informal code representation, or a combination thereof. The source code in a program can comprise source code from one or more programming languages, including general-purpose languages (e.g., Python, C++, Java) and domain-specific languages (e.g., SQL). A program can comprise source code written in multiple programming languages, and a program can span multiple program files or scripts. Additionally, a program can reference other programs. In embodiments where a program comprises a combination of informal code representation and source, generating executable code based on the program comprises generating the executable code from the informal code representation and the source code.

In any of the embodiments described herein, upon a program comprising informal code representation being executed, an AI runtime interprets the program and generates executable code based on the program. Upon the first execution of a program (or a first execution of a revised program), an AI runtime can infer executable code from the informal code representation (as well as any source code that may be part of the program) and execute the inferred executable code. The IDE can display the output from executing the generated executable code. If a user determines that the program is behaving as expected (i.e., that the output matches expected results), the IDE can receive an indication from the user that the program is operating as expected (i.e., that the executable code is valid), and the IDE can identify the executable code as validated executable code. The IDE can store validated executable code (either locally or remotely) for retrieval during subsequent program execution. In some embodiments, validated executable code can be stored in a local execution cache. Information indicating the informal code representation that validated executable code is associated with can be stored with the validated executable code or in another suitable approach. Multiple validated executable code files can be associated with different portions of a program comprising informal code representation.

In subsequent executions of the program, rather than reinterpreting the program and regenerating executable code, the AI runtime can retrieve and execute validated executable code associated with the program. That is, the executable code associated with the program comprises validated executable code. In some embodiments, an AI runtime can retrieve and execute validated executable code associated with portions of a program that have not changed since the executable code was validated, and interpret and generate executable code for portions of a program that have been revised and are being executed in their revised form for the first time or for portions of a program that are new and have not been previously executed. By retrieving and executing validated executable code in subsequent runs of a program, consistent results across successive runs of a program can be ensured.

In some embodiments, the technologies described herein provide for detecting programs that are partially implemented or that have missing logic. In such embodiments, an IDE can infer, execute, and refine missing parts of a program. Programs that an IDE infers as having missing parts can be referred to as “partial implementations” or “incomplete code”. An AI runtime can detect partial implementations based on syntactic or semantic gaps within the code and can infer missing logic using one or more contextual indicators, such as developer-provided comments, structured annotations (e.g., machine-interpretable annotations embedded within the source code that specify intended logic, data flow, or functional relationships), and validated executable code, or previously inferred logic stored in an execution cache.

By enabling the execution of partial implementations by dynamically resolving missing logic, developer's cognitive burden can be eased, and prototyping of programs can be accelerated, which can facilitate learning for newer programmers.

In any of the embodiments, described herein, if an AI runtime determines that a program is a partial implementation or is incomplete code, and infers one or more missing parts of the program during executable code generation, the AI runtime can incorporate inferred executable code corresponding to the determined missing parts into the executable code corresponding to the remainder of the program, without the AI runtime modifying the original program. That is, the original source code and informal code representation in the program remain unaltered, thereby preserving the developer's intent.

In any of the embodiments disclosed herein, source code included in a program can comprise any number of functions, and different portions of the source code can be written in different programming languages. The programming language that corresponds to source code in a program file can be identified by comments or pseudocode in the program. In some embodiments, the runtime can infer the programming language that the source code in a program is written in.

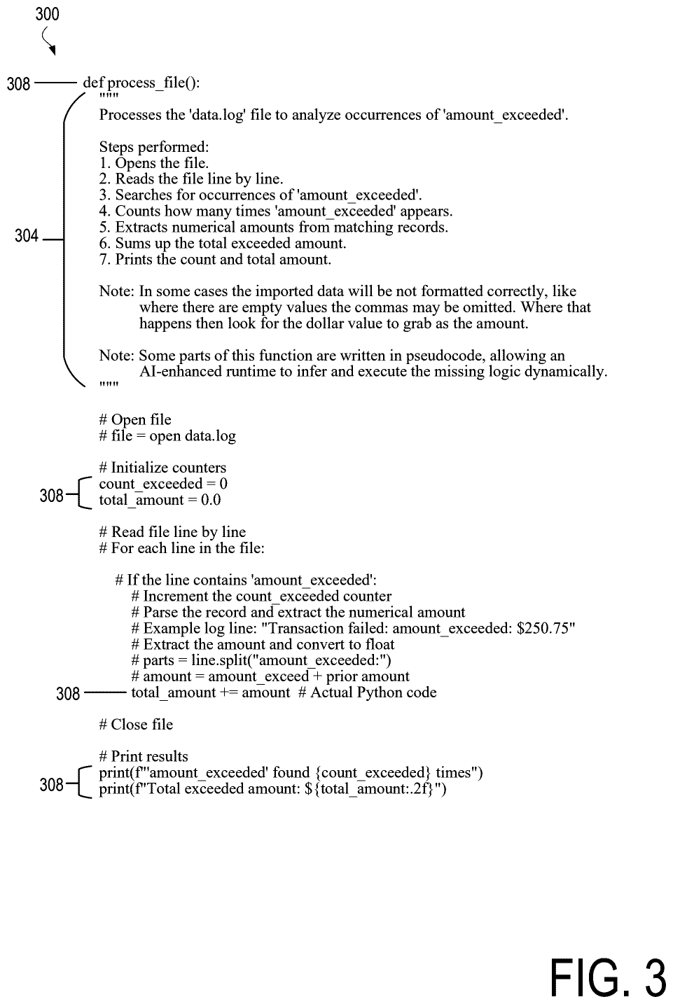

FIG. 3 illustrates an example program comprising source code and informal code representation. The program 300 comprises Python code with multi-line comments 304 (delimited by triple quotes) and single-line comments that begin with a “#” character. It is to be noted that only several lines (lines 308) in the program 300 comprise Python code, while the remainder of the program comprises pseudocode or natural language. When the program 300 is executed using the technologies described herein, executable code is inferred from the comments to implement the program developer's intent expressed in the comments.

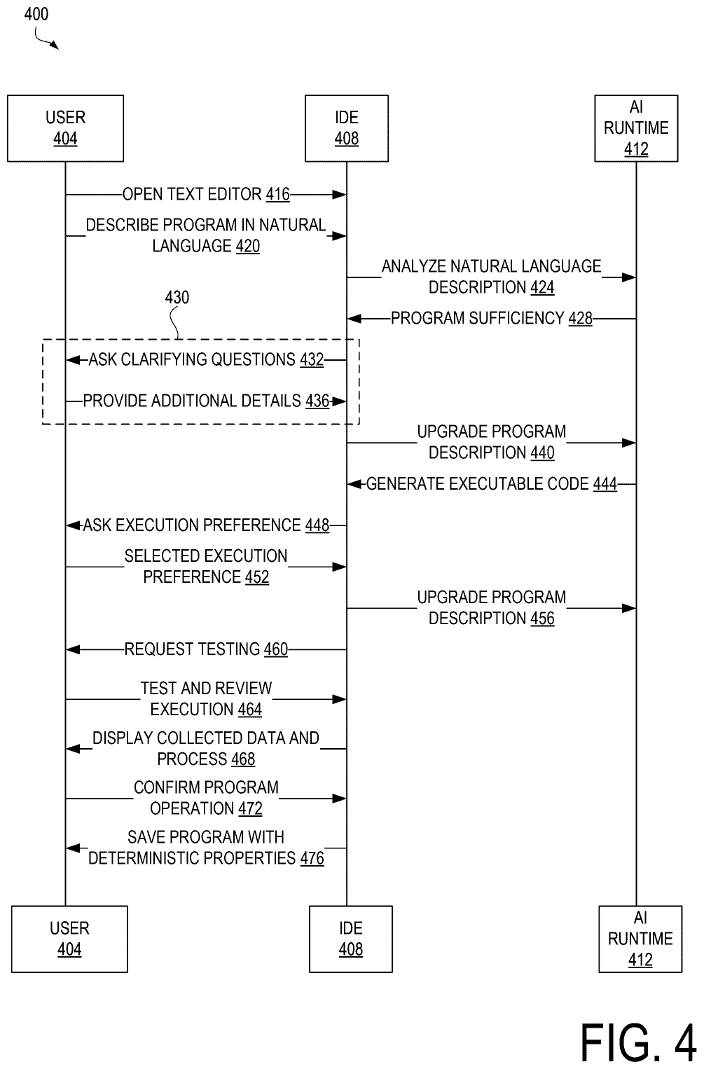

FIG. 4 illustrates a sequence diagram for an example interaction between a user and a system to execute a program comprising entirely informal code representation. The sequence 400 outlines the interactions between a user 404, an IDE 408, and an AI runtime 412 that can be part of or invoked by the IDE 408 to execute a program comprising informal code representation generally, and is presented in the context of a user Alice desiring to write a program to generate a sales report from multiple spreadsheets. The IDE 408 and the AI runtime 412 can be operating on the same computing system or different computing systems. In an initial operation 416, Alice enters natural language into a text editor in the IDE 408 to express her intent of what she wants her program to perform. In an operation 420, Alice types the following:
Find all of the Excel files in my sales_reports directory.
Find the quantity ordered and sum them all up.

Alice causes her natural language program to be executed, and as a result, the IDE 408 causes, in an operation 424, the AI runtime 412 to analyze the natural program for sufficiency if the program is descriptive enough (i.e., if there is any missing logic). As a result of the AI runtime 412 analyzing one or more of the spreadsheets in the “sales_reports” directory, it determines that the program is insufficient to achieve the user's intent. In particular, the AI runtime 412 determines that the program is sufficient in describing how the ordered quantities are to be summed up, given the content of the spreadsheets in the sales_report directory. In an operation 428, the AI runtime 412 informs the IDE 408 whether the program has been described sufficiently or not (in this case, insufficiently). In the case that the program is insufficient, the IDE 408 can prompt the user with one or more clarifying questions, and the user can provide additional details, as indicated in FIG. 4 with a dashed box 430 around operation 432 and operation 436, which are optional. In the example, the IDE 408 prompts Alice with the following clarifying question in an operation 432:
I found in each spreadsheet file several worksheets that each have a “quantity ordered” column. Do you want all of worksheets within each file summed up or just one (ytd_sales, 2024 sales, 2023 sales)?

In an operation 436, Alice enters into the text editor:
Just ytd_sales.

In response, in an operation 440, the IDE 408 has the AI runtime 412 update the program “code” as follows:
Find all of the Excel files in my sales reports directory.
Only ytd_sales worksheet.
Find the quantity ordered and sum them all up.

With the program now determined to be sufficiently expressing the user's intent, the AI runtime 412 generates executable code and informs the IDE 408 in an operation 444 that executable code has been generated. The IDE then asks Alice, in an operation 448, for an execution preference for the program. A program can be implemented from a command line, within a graphical interface, within an application action (e.g., a toolbar button or a drop-down menu option), or in any other suitable form. In an operation 452, Alice responds with her preferred execution method:
I would like a button in the Excel toolbar.

The system then updates the program in an operation 456 as follows:
Find all of the excel files in my sales reports directory.
Only ytd_sales worksheet.
Find the quantity ordered and sum them all up.
Execute with a button in Excel toolbar.

In some embodiments, operation 448 and operation 452 are optional and a default execution mode is utilized. With executable code generated for the program, in an operation 460, the system asks Alice via the IDE 408 if she would like to test the program. In an operation 464, Alice requests that the program be executed for testing and that she would like to review the program execution (e.g., how the system collected data and calculated the order quantity sum for each spreadsheet). The IDE 408 causes the AI runtime 412 to execute the executable code, displays the generated output, and displays the requested execution details (the collected data and how the quantity ordered sum was calculated) in an operation 468. The system generates executable code from the program, calculates the quantity ordered in the ytd_sales worksheet in each file, displays this information as output, and displays how these sums were calculated. Alice reviews the output and how the sums were calculated, and in operation 472, confirms that the program operates as expected. The IDE 408, in an operation 476, then saves the executable code as validated executable code along with an indication that the validated executable code is associated with Alice's program. This validated executable code can be stored on a local computing system or device that Alice is operating.

Several things in the foregoing example are to be noted. First, the system maintains continuity in the stylistic conventions employed by the user to express their intent. The computing system kept the code in natural language form as it made its revisions and did not generate or display any source code for inclusion in the program. However, if Alice were to have employed a combination of natural language and source code in her program (for example, Python expressions intermixed with descriptive text), the system may have made additions and revisions to the program in a similar manner (i.e., via additions and revisions to the natural language and/or source code). Second, the resulting program is stored in the form in which it was recorded (in natural language form), with determinism (e.g., with the metadata and structural instructions as discussed below).

Third, the program is saved within a storage accessible to both the large language model (LLM) that is part of the AI runtime and the user, such as a shared local or network-accessible directory. The stored program corresponds to the user-authored code as augmented or modified by the AI runtime. Fourth, depending on the operational context, portions of the program may be interpreted (if the executable code comprises informal code representation) or compiled (if the program comprises source code). Fifth, it is again noted that the system updated the program without generating or displaying source code (e.g., C# or Python source code).

In some embodiments, as part of generating executable code from a program comprising informal code representation and source code, the system can determine which portions of the program comprise informal code representation and which portions of the program comprise source code.

Natural-language programming presents challenges related to nondeterminism and ambiguity. The disclosed technologies mitigate such issues by considering the natural-language expressions as the canonical programmatic representation. This is achieved through contextual observations, wherein a system records and associates background information with corresponding user-authored code segments. Such recorded observations form metadata and structural instructions defining aspects of a program. These metadata and structural instructions can be saved with a program. For example, as part of interacting with a user to resolve program ambiguity (such as the system querying the user regarding the ambiguity and the system receiving responses from the user regarding those prompts), the system can store information indicating how a detected ambiguity was resolved. This information can be stored as metadata or structural instructions that a system can use for future runs of the program.

In some embodiments, disambiguation metadata can comprise information sufficient to reproduce the resolution of ambiguity in future executions of a program. The disambiguation metadata may include, for example, identifiers of the ambiguous portions of a program, the corresponding informal code representation, a structural or semantic representation of the ambiguity, a classification of the ambiguity type, and data representing the user-provided resolution of the ambiguity (e.g., “the ‘folder’ in the informal code representation refers to/data/archive”, a chosen option out of multiple candidates presented (e.g., which interpretation of user intent was selected and which were rejected)). The metadata can further include environmental context information, such as runtime variables or data state at the time of disambiguation. In some embodiments, the metadata may also include a learned rule or mapping associating the ambiguous expression with a specific resolution. Such metadata enables the system to automatically resolve recurring ambiguities in subsequent runs of the natural language program under similar contextual conditions.

In some embodiments, a system can automatically modify informal code representation as part of a system detecting and resolving an ambiguity in the informal code representation. For example, in some embodiments, in response to one or more interactions between a system and user comprising the system presenting prompts to a user regarding a program ambiguity and the user providing responses to the prompts, the system can automatically modify the informal code representation in the program to create modified informal code representation. Executable code can be generated from the modified informal code representation. A user can then be prompted to whether the executable code generated from the modified informal code representation performs as desired and thus be validated as validated executable code.

Over successive interactions with the user, a system employing the technologies disclosed herein can observe and adapt to user behavior and preferences. Each interaction contributes additional programmatic examples and contextual data that the system can utilize to refine subsequent engagements and improve the quality of programs comprising informal code representation.

In some embodiments, an LLM execution bridge may be utilized to provide communication between an LLM-based processing system (which can be part of an AI runtime) and an IDE. In some embodiments, the interface of the LLM execution bridge can comprise a server-side component that interfaces with a server-based LLM-based processing system for LLM processing of program code and a client-side component that interfaces with a client-based (e.g., user laptop or desktop computer) component configured for model processing and executable code execution. In some embodiments, the client-side system automatically detects and registers available executable environments on a computing device for use by an LLM execution bridge. Such environments may include application-embedded runtimes (e.g., Microsoft® Visual Basic for Applications (VBA) within Excel), command-line interpreters (e.g., Perl), or local database engines (e.g., SQLite3). Upon discovery, a system can associate these environments with an LLM execution bridge interface, enabling dynamic generation and execution of code in accordance with a user's operational context.

In some embodiments, a program can comprise multiple program files (documents, scripts), with each program file comprising distinct functions, modules, or services. Each program file can comprise pseudocode, informal code representation, or a combination thereof, and any program file can reference other program files comprising informal code representation to establish logical or functional relationships among them. Such cross-referencing allows a set of individual program files to be combined into an overall program structure in which functions and data definitions are shared across multiple program files. The relationships between these files may be explicitly declared through syntax or metadata or may be inferred by a computing system utilizing the technologies disclosed herein through contextual analysis of the referenced files. In some embodiments, an IDE can provide for multiple programs to be displayed in multiple text editors, allowing a user to work with multiple program files (any of which may contain a reference to another program file) simultaneously.

When execution of a program is initiated, the user may store the program (comprising informal code representation) in the user's home directory (e.g., ˜/web_application.ai). The program may be monolithic or modular in nature, and may be launched through a standard operating system command (e.g., ˜/systemctl start web_application.txt) or equivalent invocation. Program execution may be managed by a background or server-side service (e.g., ai.application.service,), although in some embodiments the service may operate entirely on the client side.

In some embodiments, upon execution of a program, a service perform can review the program and, in the case where there are multiple program files, identify their interrelationships, cross-references, and dependencies; determine an appropriate build or runtime environment for execution; compile or translate the program into one or more target languages, such as Python, GoLang, or C++, or directly into bytecode or machine code; when an interpreted execution path is selected, store the resulting bytecode or intermediate representation for reuse; detect and initialize dependent services, such as NGINX, FastAPI, SQLite3, or MariaDB; and generate a containerization descriptor, such as a Dockerfile, when deployment in a containerized environment is indicated.

The service may further maintain mappings among interdependent program files and functions comprising a program, thereby ensuring consistency and coherence during compilation, execution, and runtime management. Through this arrangement, programs defined across multiple files can be executed as unified applications while preserving their logical cross-references and functional integrity.

In some embodiments, an IDE user interface can include a window that renders a synchronized view of generated source code and informal code representation in real time so that a user can observe how prompt edits modify a program. Portions of a program that are inferred to have multiple interpretations that would lead to execution in different ways, and thus, potentially leading to different results, may be flagged as ambiguous, and the system can present two or more proposed program modifications or additions for user selection. In some embodiments, the system infers missing logic from project context and prior interactions and may prompt users with clarifying questions when confidence thresholds are not met, to, for example, avoid irritating the user or avoid increasing the cognitive load on the user. During debugging, if a program's output continues to differ from expected results, the system can increase the granularity of clarifying prompts to validate that interpretations of the code made by the system align with the user's intent.

In certain implementations, an IDE can provide a tiered error handling and debugging framework that addresses issues arising from LLM model limitations, a program not clearly articulating a user's intent, and/or runtime faults. At a first level, a system can evaluate a program for incompleteness or ambiguity and prompt a user for additional information. In embodiments where a synchronized view of generated source code and informal code representation is displayed and/or where ambiguous code is flagged, these can be updated as a user provides additional information. If a user is dissatisfied with a program's performance after clarifying questions have been asked and the program modified in response to those clarifying questions, the system can ask further clarifying questions to discern the user's intent.

At a second level, when testing a program fails due to a program not providing expected results, a system can analyze the program failure in the context of the information provided by the user and automatically revise the program to generate modified informal code representation. Optionally, the modified program can be rerun automatically. That is, executable code can be generated from the modified informal code representation, and the executable code can be executed. At a third level, a system can engage in a natural language dialog with the user. For example, a user can ask questions about partial results during intermediate phases of program execution, such as, “What is the quantity ordered after processing ten rows of the spreadsheet1.xls file?” This interaction can help identify and eliminate the root causes of errors.

In some embodiments, the technologies described herein can implement security and privacy controls for programs, including informal code representation as well as executable code associated with such programs. These security and privacy controls can include encryption in transit and at rest, granular access control, and audit logging. Deployments can be configured for the generation and execution of executable code at user computing devices or systems or for privacy-preserving cloud processing. Approaches such as tenant isolation and policy enforcement can govern data residency, program and executable code usage, and retention lifecycles across authoring and execution operations.

In some embodiments, the IDE user interface incorporates a feedback loop that records user approvals, rejections, annotations, and ratings of generated outputs and disambiguation choices. These signals are stored as preferences at the user level or at a project level and are used to adjust program interpretation, rank alternatives, and bias future executable code generation toward preferred logic, code libraries, and/or code architectures.

In some embodiments, the technologies described herein can determine, based on the source code and/or informal code representation in a program, to pull in one or more of source code, bytecode, or machine code libraries or modules. These libraries or modules can be standard libraries or modules that are part of a programming language's ecosystem (e.g., C++ standard template library (STL), Python “math” module) or other executable code previously generated (e.g., validated executable code generated from programs comprising informal code representation). In some embodiments, a system employing the technologies described herein can select which libraries or modules to include in source code, bytecode, or machine code based on informal code representation or other information provided to the system by the user, such as replies to clarifying prompts.

In some embodiments, an IDE user interface can comprise a user interface that comprises a program editor (a text editor), a synchronized generated code window (if source code is part of a program), an ambiguity and warnings ribbon, execution status indicators, and/or a difference inspector that visualizes changes attributable in source code or informal code representation of a program in response to specific prompts or system inferences. In some embodiments, cross-references among program files and functions can be navigable via hyperlinks and call graphs.

In some embodiments, a system can generate intermediate code from a program comprising informal code representation that lies at a level of abstraction between the program and executable code. In some embodiments, this intermediate code can be source code that conforms to any programming language syntax. In cases where a program comprises source code, the intermediate code could be source code in the same programming language as the source code in the program. In some embodiments, a system can determine automatically which programming language to use for the intermediate code based on, for example, the system determining that a specific programming language would be advantageous for the intermediate code to be realized in. For example, a system may decide that using the Python “pandas” data analysis and manipulation library would be advantageous and use Python as the programming language for the intermediate code. In such a case, the system can provision a Python environment and install the appropriate Python libraries as needed. In some embodiments, the program can comprise informal code representation that indicates which intermediate code to use. Further, in some embodiments, a system can be configured with information of the computing system on which executable code generated from a program is to be run. In some embodiments, the system can generate executable code for use in more generalized computing system contexts, such as for use in containers or web servers.

In some embodiments, any intermediate code generated by a system can be ephemeral, and a user would not need to interact with it. A system may store intermediate code temporarily (i.e., only during the length of an IDE session) in a local cache, but the definitive programmatic intent would be the program from which the intermediate code was derived. It is the program comprising informal code representation (as well as possibly source code) that would be stored for later retrieval and execution in a subsequent IDE session.

In some embodiments, a system utilizing the technologies described herein can incorporate or interoperate with frameworks such as the Secure Architecture Forum (SAFE) to promote the generation of intermediate source code, bytecode, or executable code that conforms to defined security and architectural requirements. The system may include functionality for integrating SAFE guidelines, standards, or policies within its operational logic so that relevant security controls and design constraints are automatically applied according to a user's program.

In certain embodiments, the system may access one or more repositories containing security or architectural specifications, dynamically retrieving and applying such information during interactive program development sessions. Similar to a retrieval-augmented generation (RAG) system, the invention may reference, interpret, and implement guidelines, standards, etc. (e.g., Secure Architecture Forum requirements) in real time as the user interacts with the system.

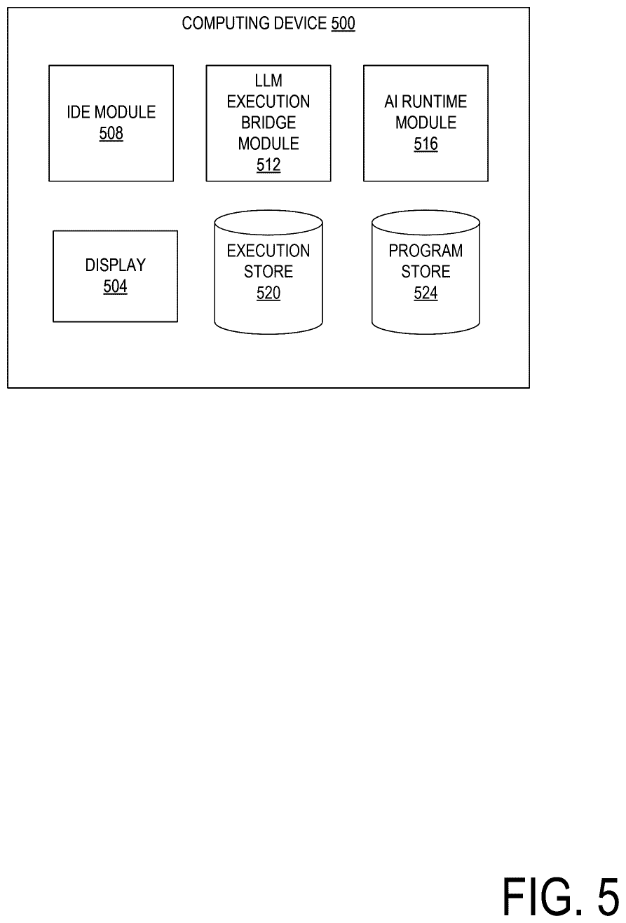

FIG. 5 is a block diagram of a first example computing device capable of generating and executing executable code from a program comprising informal code representation. The computing device 500 comprises a display 504, an IDE module 508, an LLM execution bridge module 512, an AI runtime module 516, an execution store 520, and a program store 524. The IDE module 508 is an integrated development environment that a user can interact with via a display 504 (and one or more input devices, not shown). The LLM execution bridge module 512 provides an interface between the IDE module 508 and the AI runtime module 516. The AI runtime module 516 is capable of generating and executing executable code from a program comprising informal code representation. The execution store 520 can store validated executable code. The AI runtime module 516 can cause executable code to be stored in and retrieved from the execution store 520. The execution store 520 can be implemented as any store located in one or more levels of a memory and storage hierarchy local to the computing device 500, such as a cache. The program store 524 can comprise programs comprising informal code representation.

It is to be understood that FIG. 5 illustrates one example of a set of modules that can be included in a computing device. In other embodiments, a computing device can have more or fewer modules than those shown in FIG. 5. Further, separate modules can be combined into a single module, and a single module can be split into multiple modules. Moreover, any of the modules shown in FIG. 5 can be part of an operating system or a hypervisor of the computing device 500, one or more software applications independent of the operating system or hypervisor, or operating at another software layer.

As used herein, the term “module” refers to logic that may be implemented in a hardware component or device, software, or firmware running on a processor unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processor units, state machine circuitry, and/or firmware that stores instructions executable by programmable circuitry. Modules described herein may, collectively or individually, be embodied as circuitry that forms a part of a computing system. Thus, any of the modules can be implemented as circuitry, such as AI runtime circuitry and LLM execution bridge circuitry. A computing system referred to as being programmed to perform a method can be programmed to perform the method via software, hardware, firmware, or combinations thereof.

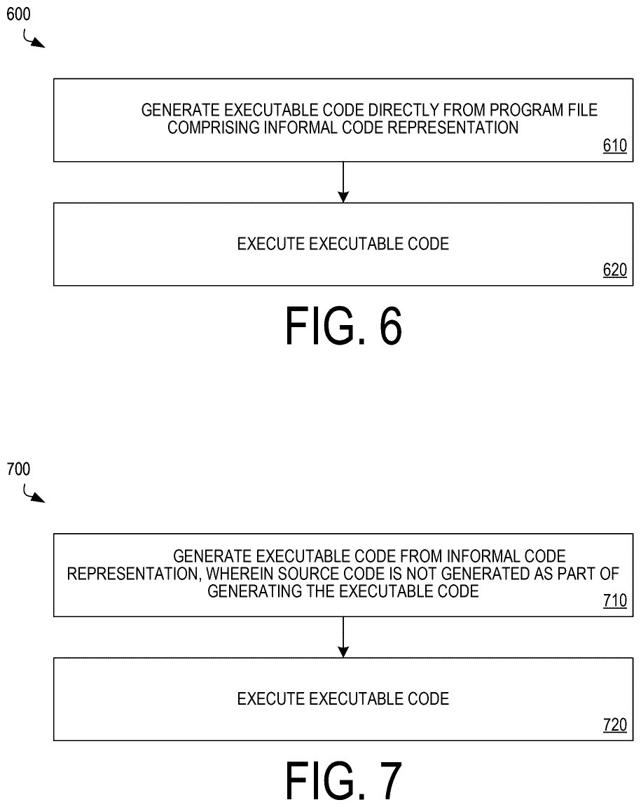

FIG. 6 is a first example method of generating executable code from a program comprising informal code representation. In stage 610 in method 600, executable code is generated directly from a program file comprising informal code representation. In stage 620, the executable code is executed.

In other embodiments, the method 600 can comprise one or more additional elements. For example, the method 600 can further comprise receiving an indication from a user that the executable code is valid; and storing the executable code as validated executable code, wherein the executable code is associated with at least a portion of the informal code representation. In another example, the method 600 can further comprise, receiving a first request to execute the program file, wherein generating the executable code and executing the executable code occur in response to receiving the first request; and executing the validated executable code in response to receiving a second request to execute the program file. In yet another example, the method 600 can further comprise determining one or more portions of the program file that comprise informal code representation. In another example, the method 600 can further comprise determining an ambiguity in the informal code representation; prompting a user to resolve the ambiguity; receiving a user response in response to prompting the user to resolve the ambiguity; modifying the informal code representation to generate modified informal code representation based on the response; generating second executable code from the modified informal code representation without generating source code; and executing the second executable code. In still another example, the method 600 can comprise prompting the user with a clarifying question regarding an intention of the informal code representation; receiving a user response in response to prompting the user with the clarifying question; modifying the informal code representation to generate modified informal code representation based on the user response; generating second executable code from the modified informal code representation without generating source code; and executing the second executable code.

FIG. 7 is a second example method of generating executable code from a program comprising informal code representation. In stage 710 in method 700, executable code is generated from informal code representation, wherein source code is not generated as part of generating the executable code from the informal code representation. In stage 720, the executable code is executed.

The technologies described herein can be performed by or implemented in any of a variety of computing systems, including mobile computing systems (e.g., tablet computers, laptop computers) and non-mobile computing systems (e.g., desktop computers, servers, workstations, rack-level computing solutions (e.g., blade, tray, or sled computing systems)).

As used herein, the term “computing system” includes computing devices and includes systems comprising multiple discrete physical components. In some embodiments, the computing systems are located in a data center, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that hosts companies' applications and data), or an edge data center (e.g., a data center typically having a smaller footprint than other data center types, located close to the geographic area that it serves).

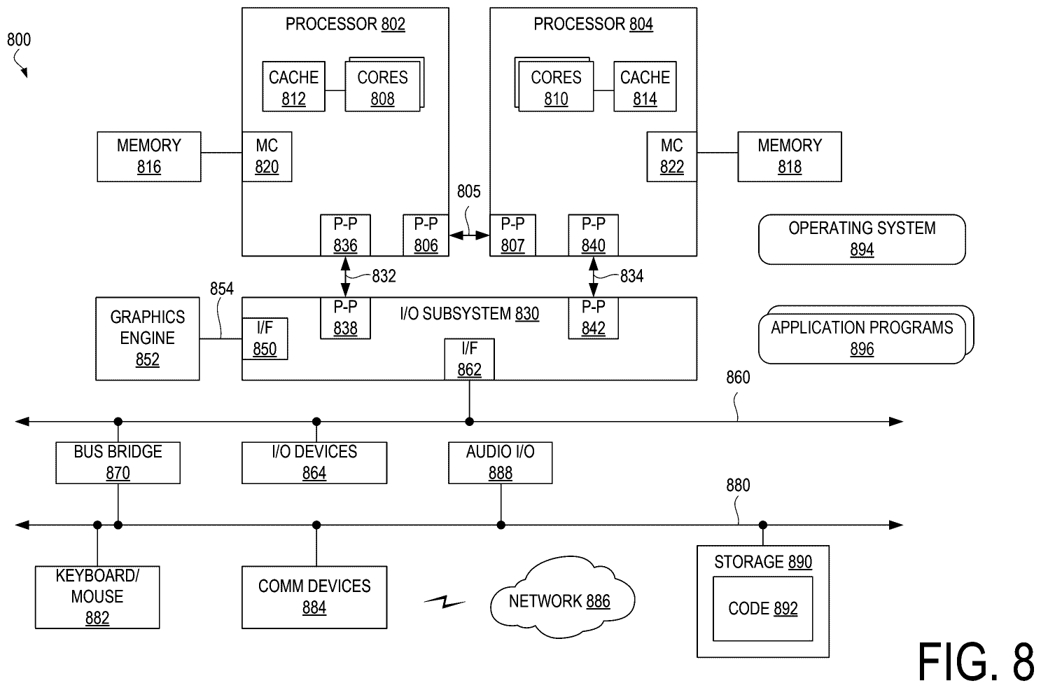

FIG. 8 is a block diagram of a second example computing device capable of generating and executing executable code from a program comprising informal code representation. Generally, components shown in FIG. 8 can communicate with other shown components, although not all connections are shown, for ease of illustration. The computing system 800 is a multiprocessor system comprising first processor unit 802 and second processor unit 804 comprising point-to-point (P-P) interconnects. A point-to-point (P-P) interface 806 of the first processor unit 802 is coupled to a point-to-point interface 807 of the second processor unit 804 via a point-to-point interconnection 805. It is to be understood that any or all of the point-to-point interconnects illustrated in FIG. 8 can be alternatively implemented as a multi-drop bus, and that any or all buses illustrated in FIG. 8 could be replaced by point-to-point interconnects.

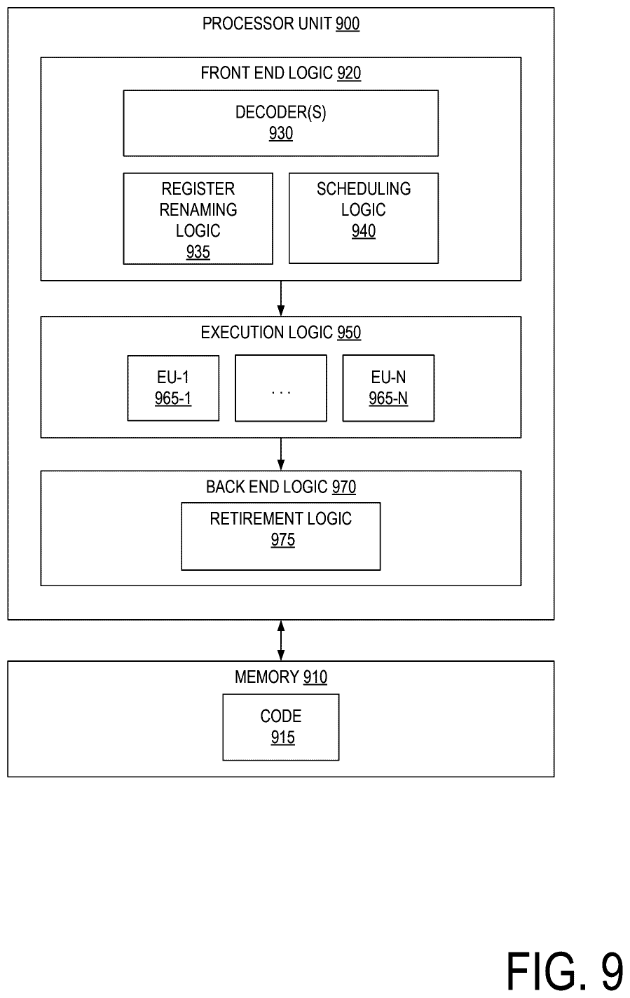

The first processor unit 802 and second processor unit 804 comprise multiple processor cores. The first processor unit 802 comprises processor cores 808 and the second processor unit 804 comprises processor cores 810. Processor cores 808 and 810 can execute computer-executable instructions in a manner similar to that discussed below in connection with FIG. 9, or other manners.

The first processor unit 802 and the second processor unit 804 further comprise cache memories 812 and 814, respectively. The cache memories 812 and 814 can store data (e.g., instructions) utilized by one or more components of the first processor unit 802 and the second processor unit 804, such as the processor cores 808 and 810. The cache memories 812 and 814 can be part of a memory hierarchy for the computing system 800. For example, the cache memories 812 can locally store data that is also stored in a first memory 816 to allow for faster access to the data by the first processor unit 802. In some embodiments, the cache memories 812 and 814 can comprise multiple cache memories that are a part of a memory hierarchy. The cache memories in the memory hierarchy can be at different cache memory levels, such as level 1 (L1), level 2 (L2), level 3 (L3), level 4 (L4), or other cache memory levels. In some embodiments, one or more levels of cache memory (e.g., L2, L3, L4) can be shared among multiple cores in a processor unit or among multiple processor units in an integrated circuit component. In some embodiments, the last level of cache memory in an integrated circuit component can be referred to as a last-level cache (LLC). One or more of the higher levels of cache levels (the smaller and faster cache memories) in the memory hierarchy can be located on the same integrated circuit die as a processor core and one or more of the lower cache levels (the larger and slower caches) can be located on one or more integrated circuit dies that are physically separate from the processor core integrated circuit dies.

Although the computing system 800 is shown with two processor units, the computing system 800 can comprise any number of processor units. Further, a processor unit can comprise any number of processor cores. A processor unit can take various forms such as a central processing unit (CPU), graphics processing unit (GPU), general-purpose GPU (GPGPU), accelerated processing unit (APU), field-programmable gate array (FPGA), neural network processing unit (NPU), data processor unit (DPU), accelerator (e.g., graphics accelerator, digital signal processor (DSP), compression accelerator, artificial intelligence (AI) accelerator), controller, or other type of processing unit. As such, the processor unit can be referred to as an XPU (or xPU). Further, a processor unit can comprise one or more of these various types of processing units. In some embodiments, the computing system comprises one processor unit with multiple cores, and in other embodiments, the computing system comprises a single processor unit with a single core. As used herein, the terms “processor unit” and “processing unit” can refer to any processor, processor core, component, module, engine, circuitry, or any other processing element described or referenced herein.

In some embodiments, the computing system 800 can comprise one or more processor units that are heterogeneous or asymmetric to another processor unit in the computing system. There can be a variety of differences between the processing units in a system in terms of a spectrum of metrics of merit including architectural, microarchitectural, thermal, power consumption characteristics, and the like. These differences can effectively manifest themselves as asymmetry and heterogeneity among the processor units in a system.

The first processor unit 802 and the second processor unit 804 can be located in a single integrated circuit component (such as a multi-chip package (MCP) or multi-chip module (MCM)) or they can be located in separate integrated circuit components. An integrated circuit component comprising one or more processor units can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor unit, or on one or more integrated circuit dies separate from any integrated circuit die containing a processor unit. In some embodiments, these separate integrated circuit dies can be referred to as “chiplets”. In some embodiments, where there is heterogeneity or asymmetry among processor units in a computing system, the heterogeneity or asymmetric can be among processor units located in the same integrated circuit component. In embodiments where an integrated circuit component comprises multiple integrated circuit dies, interconnections between dies can be provided by a package substrate, one or more silicon interposers, one or more silicon bridges embedded in a package substrate (such as Intel® embedded multi-die interconnect bridges (EMIBs)), or combinations thereof.

The first processor unit 802 further comprises first memory controller logic (first MC 820) and the second processor unit 804 further comprises second memory controller logic (second MC 822). As shown in FIG. 8, a first memory 816 coupled to the first processor unit 802 is controlled by the first MC 820 and a second memory 818 coupled to the second processor unit 804 is controlled by the second MC 822. The first memory 816 and the second memory 818 can comprise various types of volatile memory (e.g., dynamic random-access memory (DRAM), static random-access memory (SRAM)) and/or non-volatile memory (e.g., flash memory, chalcogenide-based phase-change non-volatile memories). The first memory 816 and the second memory 818 can comprise one or more layers of a memory hierarchy of the computing system. While first MC 820 and second MC 822 are illustrated as being integrated into the first processor unit 802 and the second processor unit 804, in alternative embodiments, memory controller logic can be external to a processor unit.

The first processor unit 802 and the second processor unit 804 are coupled to an Input/Output subsystem 830 (I/O subsystem) via point-to-point interconnection 832 and point-to-point interconnection 834. The point-to-point interconnection 832 connects a point-to-point interface 836 of the first processor unit 802 with a point-to-point interface 838 of the Input/Output subsystem 830, and the point-to-point interconnection 834 connects a point-to-point interface 840 of the second processor unit 804 with a point-to-point interface 842 of the Input/Output subsystem 830. Input/Output subsystem 830 further includes an interface 850 to couple the Input/Output subsystem 830 to a graphics engine 852. The Input/Output subsystem 830 and the graphics engine 852 are coupled via a bus 854.

The Input/Output subsystem 830 is further coupled to a first bus 860 via an interface 862. The first bus 860 can be a Peripheral Component Interconnect Express (PCIe) bus or any other type of bus. Various I/O devices 864 can be coupled to the first bus 860. A bus bridge 870 can couple the first bus 860 to a second bus 880. In some embodiments, the second bus 880 can be a low pin count (LPC) bus. Various devices can be coupled to the second bus 880 including, for example, a keyboard/mouse 882, audio I/O devices 888, and a storage device 890, such as a hard disk drive, solid-state drive, or another storage device for storing computer-executable instructions (or code 892) or data. The code 892 can comprise computer-executable instructions for performing methods described herein. Additional components that can be coupled to the second bus 880 include one or more communication devices 884, which can provide for communication between the computing system 800 and one or more wired or wireless networks 886 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 502.11 standard and its supplements).

In embodiments where the one or more communication devices 884 support wireless communication, the one or more communication devices 884 can comprise wireless communication components coupled to one or more antennas to support communication between the computing system 800 and external devices. The wireless communication components can support various wireless communication protocols and technologies such as IEEE 1002.11 (Wi-Fi) variants and Bluetooth. In addition, the wireless modems can support communication with one or more cellular networks for data and voice communications within a single cellular network, between cellular networks, or between the computing system and a public switched telephone network (PSTN).

The computing system 800 can comprise removable memory such as flash memory cards. The memory in computing system 800 (including cache memories 812 and 814, first memory 816, second memory 818, and storage device 890) can store data and/or computer-executable instructions for executing an operating system 894 and application programs 896. The computing system 800 can also have access to external memory or storage (not shown) such as external hard drives or cloud-based storage.

The operating system 894 can control the allocation and usage of the components illustrated in FIG. 8 and support the application programs 896. The application programs 896 can include common computing system applications (e.g., email applications) as well as other computing applications.

In some embodiments, a hypervisor (or virtual machine manager) operates on the operating system 894 and the application programs 896 operate within one or more virtual machines operating on the hypervisor. In these embodiments, the hypervisor is a type-2 or hosted hypervisor as it is running on the operating system 894. In other hypervisor-based embodiments, the hypervisor is a type-1 or “bare-metal” hypervisor that runs directly on the platform resources of the computing system 800 without an intervening operating system layer.

In some embodiments, the application programs 896 can operate within one or more containers. A container is a running instance of a container image, which is a package of binary images for one or more of the application programs 896 and any libraries, configuration settings, and any other information that the application programs 896 need for execution. A container image can conform to any container image format, such as Docker®, Appc, or LXC container image formats. In container-based embodiments, a container runtime engine, such as Docker Engine, LXU, or an open container initiative (OCI)-compatible container runtime (e.g., Railcar, CRI-O) operates on the operating system (or virtual machine monitor) to provide an interface between the containers and the operating system 894. An orchestrator can be responsible for management of the computing system 800 and various container-related tasks such as deploying container images to the computing system 800, monitoring the performance of deployed containers, and monitoring the utilization of the resources of the computing system 800.

The computing system 800 can support various additional input devices, such as a touchscreen, microphone, camera or touchpad, and one or more output devices, such as one or more speakers or displays. Any of the input or output devices can be internal to, external to, or removably attachable with the computing system 800. External input and output devices can communicate with the computing system 800 via wired or wireless connections. The computing system 800 can further include at least one input/output port comprising physical connectors (e.g., USB) and a power supply (e.g., battery).

It is to be understood that FIG. 8 illustrates only one example computing system architecture. Computing systems based on alternative architectures can be used to implement technologies described herein. For example, instead of the first processor unit 802, the second processor unit 804, and the graphics engine 852 being located on discrete integrated circuit dies, a computing system can comprise an SoC (system-on-a-chip) integrated circuit die on which multiple processors, a graphics engine, and additional components are incorporated. Further, a computing system can connect its constituent component via bus or point-to-point configurations different from that shown in FIG. 8. Moreover, the illustrated components in FIG. 8 are not required or all-inclusive, as shown components can be removed and other components added in alternative embodiments.

FIG. 9 is a block diagram of an example processor unit to execute computer-executable instructions as part of implementing technologies described herein. The processor unit 900 can be a single-threaded core or a multithreaded core in that it may include more than one hardware thread context (or “logical processor”) per processor unit.

FIG. 9 also illustrates a memory 910 coupled to the processor unit 900. The memory 910 can be any memory described herein or any other memory known to those of skill in the art. The memory 910 can store computer-executable instructions 915 (code) executable by the processor unit 900.

The processor unit comprises front-end logic 920 that receives instructions from the memory 910. An instruction can be processed by one or more decoders 930. The one or more decoders 930 can generate as its output a micro-operation such as a fixed width micro-operation in a predefined format, or generate other instructions, microinstructions, or control signals, which reflect the original code instruction. The front-end logic 920 further comprises register renaming logic 935 and scheduling logic 940, which generally allocate resources and queues operations corresponding to converting an instruction for execution.

The processor unit 900 further comprises execution logic 950, which comprises one or more execution units (EUs) (execution unit 965-1 through execution unit 965-N). Some processor unit embodiments can include a number of execution units dedicated to specific functions or sets of functions. Other embodiments can include only one execution unit or one execution unit that can perform a particular function. The execution logic 950 performs the operations specified by code instructions. After completion of execution of the operations specified by the code instructions, back-end logic 970 retires instructions using retirement logic 975. In some embodiments, the processor unit 900 allows out of order execution but requires in-order retirement of instructions. Retirement logic 975 can take a variety of forms as known to those of skill in the art (e.g., re-order buffers or the like).

The processor unit 900 is transformed during execution of instructions, at least in terms of the output generated by the one or more decoders 930, hardware registers and tables utilized by the register renaming logic 935, and any registers (not shown) modified by the execution logic 950.

Any of the disclosed methods (or a portion thereof) can be implemented as computer-executable instructions or a computer program product. Such instructions can cause a computing system or one or more processor units capable of executing computer-executable instructions to perform any of the disclosed methods. As used herein, the term “computer” refers to any computing system, device, or machine described or mentioned herein as well as any other computing system, device, or machine capable of executing instructions. Thus, the term “computer-executable instruction” refers to instructions that can be executed by any computing system, device, or machine described or mentioned herein as well as any other computing system, device, or machine capable of executing instructions.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used herein, the term “coupled” may indicate elements cooperate or interact with each other, but they may or may not be in direct physical or electrical contact. Furthermore, the terms “comprising,” “including,” “having,” and the like, as used with respect to embodiments of the present disclosure, are synonymous.

As used herein, the term “integrated circuit component” refers to a packaged or unpacked integrated circuit product. A packaged integrated circuit component comprises one or more integrated circuit dies mounted on a package substrate with the integrated circuit dies and package substrate encapsulated in a casing material, such as a metal, plastic, glass, or ceramic. In one example, a packaged integrated circuit component contains one or more processor units mounted on a substrate with an exterior surface of the substrate comprising a solder ball grid array (BGA). In one example of an unpackaged integrated circuit component, a single monolithic integrated circuit die comprises solder bumps attached to contacts on the die. The solder bumps allow the die to be directly attached to a printed circuit board. An integrated circuit component can comprise one or more of any computing system component described or referenced herein or any other computing system component, such as a processor unit (e.g., system-on-a-chip (SoC), processor core, graphics processor unit (GPU), accelerator, chipset processor), I/O controller, memory, or network interface controller.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the software or firmware instructions are not actively being executed by the system, device, platform, or resource.

As used in this application and the claims, a list of items joined by the term “and/or” can mean any combination of the listed items. For example, the phrase “A, B, and/or C” can mean A; B; C; A and B; A and C; B and C; or A, B and C. As used in this application and the claims, a list of items joined by the term “at least one of” can mean any combination of the listed terms. For example, the phrase “at least one of A, B, or C” can mean A; B; C; A and B; A and C; B and C; or A, B, and C. Further, as used in this application and the claims, a list of items joined by the term “one or more of” can mean any combination of the listed terms. For example, the phrase “one or more of A, B, and C” can mean A; B; C; A and B; A and C; B and C; or A, B, and C. Moreover, as used in this application and the claims, a list of items joined by the term “one of” can mean any one of the listed terms. For example, the phrase “one of A, B, or C” can mean A, B, or C.

As used in this application and the claims, the phrase “individual of” or “respective of” following by a list of items recited or stated as having a trait, feature, etc. means that all of the items in the list possess the stated or recited trait, feature, etc. For example, the phrase “individual of A, B, or C, comprise a sidewall” or “respective of A, B, or C, comprise a sidewall” means that A comprises a sidewall, B comprises sidewall, and C comprises a sidewall.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

The following examples pertain to additional embodiments of technologies disclosed herein.

Example 1 is a method comprising: generating executable code directly from a program file comprising informal code representation; and executing the executable code.

Example 2 comprises a method of example 1, wherein the program file further comprises source code, generating the executable code directly from the program file comprising generating executable code from the source code and the informal code representation.

Example 3 is a method comprising: generating executable code from informal code representation, wherein source code is not generated as part of generating the executable code from the informal code representation; and executing the executable code.

Example 4 comprises a method of example 1 or 2, wherein the executable code is bytecode.

Example 5 comprises a method of example 1 or 2, wherein the executable code is machine code.

Example 6 comprises a method of any one of examples 1-4, wherein the executable code comprises validated executable code associated with at least a portion of the informal code representation.

Example 7 comprises a method of any one of examples 1-4, wherein generating the executable code comprises inferring executable code from the informal code representation.

Example 8 comprises a method of example 7, further comprising: receiving an indication from a user that the executable code is valid; and storing the executable code as validated executable code, wherein the valid executable code is associated with at least a portion of the informal code representation.

Example 9 comprises a method of example 8, further comprising: receiving a first request to execute the program file, wherein generating the executable code and executing the executable code occurs in response to receiving the first request; and executing the validated executable code in response to receiving a second request to execute the program file.

Example 10 comprises a method of any one of examples 1-8, the method further comprising determining one or more portions of the program file that comprise informal code representation.

Example 11 comprises a method of any one of examples 1-9, wherein generating the executable code is performed at least in part by a large language model (LLM).

Example 12 comprises a method of any one of examples 1-10, further comprising an integrated development environment (IDE) receiving the informal code representation.

Example 13 comprises a method of example 12, wherein the executable code is first executable code, the method further comprising the IDE automatically modifying the informal code representation to create modified informal code representation in response to one or more interactions between the IDE and a user, the method further comprising: generating second executable code from the modified informal code representation without generating source code; and executing the second executable code.

Example 14 comprises a method of example 13, further comprises saving the program file, wherein the program file does not comprise source code.

Example 15 comprises a method of example 13, wherein source code is not displayed to the user as part of the one or more interactions between the IDE and the user.

Example 16 comprises a method of example 13, wherein the executable code is first executable code, the method further comprising: determining an ambiguity in the informal code representation; prompting a user to resolve the ambiguity; receiving a user response in response to prompting the user to resolve the ambiguity; modifying the informal code representation to generate modified informal code representation based on the response; generating second executable code from the modified informal code representation without generating source code; and executing the second executable code.

Example 17 comprises a method of example 13, wherein the executable code is first executable code, the method further comprising: determining a program failure in response to executing the first executable code; automatically modifying the informal code representation to generate modified informal code representation in response to detecting the program failure; generating second executable code from the modified informal code representation without generating source code; and executing the second executable code.

Example 18 comprises a method of example 13, wherein the executable code is first example, the method further comprising: prompting the user with a clarifying question regarding an intention of the informal code representation; receiving a user response in response to prompting the user with the clarifying question; modifying the informal code representation to generate modified informal code representation based on the user response; generating second executable code from the modified informal code representation without generating source code; and executing the second executable code.

Example 19 comprises a method of example 1, wherein the program file is a first program file, and the informal code representation makes reference to a second program file comprising informal code representation.

Example 20 is one or more computer-readable storage media storing instructions that, when executed, cause a computing system to perform the method of any one of examples 1-19.

Example 21 is one or more computing devices comprising: one or more processors; and one or more computer-readable storage media storing instructions that, when executed, cause the one or more computing devices to perform the method of any one of examples 1-19.

1. A method comprising:
generating executable code directly from a program file comprising informal code representation; and
executing the executable code.

2. The method of claim 1, wherein the program file further comprises source code, generating the executable code directly from the program file comprising generating executable code from the source code and the informal code representation.

3. The method of claim 1, wherein the executable code is bytecode or machine code.

4. The method of claim 1, wherein the executable code comprises validated executable code associated with at least a portion of the informal code representation.

5. The method of claim 1, wherein generating the executable code comprises inferring executable code from the informal code representation.

6. The method of claim 1, wherein the executable code is first executable code, the method further comprising automatically modifying the informal code representation to create modified informal code representation in response to one or more interactions with a user, the method further comprising:
generating second executable code from the modified informal code representation without generating source code; and
executing the second executable code.

7. The method of claim 1, further comprises saving the program file, wherein the program file does not comprise source code.

8. The method of claim 1, wherein the executable code is first executable code, the method further comprising:
determining an ambiguity in the informal code representation;
prompting a user to resolve the ambiguity;
receiving a user response in response to prompting the user to resolve the ambiguity;
modifying the informal code representation to generate modified informal code representation based on the response;
generating second executable code from the modified informal code representation without generating source code; and
executing the second executable code.

9. A method comprising:
generating executable code from informal code representation, wherein source code is not generated as part of generating the executable code from the informal code representation; and
executing the executable code.

10. The method of claim 9, wherein the executable code is bytecode or machine code.

11. The method of claim 9, wherein the executable code comprises validated executable code associated with at least a portion of the informal code representation.

12. The method of claim 9, wherein generating the executable code comprises inferring executable code from the informal code representation.

13. The method of claim 12, wherein the executable code is first executable code, the method further comprising automatically modifying the informal code representation to create modified informal code representation in response to one or more interactions with a user, the method further comprising:
generating second executable code from the modified informal code representation without generating source code; and
executing the second executable code.

14. The method of claim 12, wherein the executable code is first executable code, the method further comprising:
determining a program failure in response to executing the first executable code;
automatically modifying the informal code representation to generate modified informal code representation in response to detecting the program failure;
generating second executable code from the modified informal code representation without generating source code; and
executing the second executable code.

15. One or more computer-readable storage media storing instructions that, when executed, cause one or more computing systems to:
generate executable code directly from a program file comprising informal code representation; and
execute the executable code.

16. The one or more computer-readable storage media of claim 15, wherein the executable code is bytecode or machine code.

17. The one or more computer-readable storage media of claim 15, wherein the executable code comprises validated executable code associated with at least a portion of the informal code representation.

18. The one or more computer-readable storage media of claim 15, wherein to generate the executable code comprises to infer executable code from the informal code representation.

19. The one or more computer-readable storage media of claim 15, wherein the executable code is first example, the instructions to further cause the one or more computing systems to:
prompt a user with a clarifying question regarding an intention of the informal code representation;
receive a user response in response to prompting the user with the clarifying question;
modify the informal code representation to generate modified informal code representation based on the user response;
generate second executable code from the modified informal code representation without generating source code; and
execute the second executable code.

20. The one or more computer-readable storage media of claim 15, wherein the program file is a first program file, and the informal code representation makes reference to a second program file comprising informal code representation.
